(19) United States
(12) Patent Application Publication
(10) Pub. No.: US 2019/0012052 A1
(43) Pub. Date: Jan. 10, 2019

(54) Configuration Constraints in Globalization of Features

(71) Applicant: Dell Products L.P., Round Rock, TX (US)

(72) Inventors: Luis E. Bocaletti, Chicago, IL (US); Richard L. Claice, Cedar Park, TX (US)

(73) Assignee: Dell Products L.P., Round Rock, TX (US)

(21) Appl. No.: 15/644,020

(22) Filed: Jul. 7, 2017

(51) Int. Cl. G06F 3/0484; G06F 17/22

(52) U.S. Cl. CPC G06F 3/0484; G06F 3/0482; G06F 17/2288

(57) ABSTRACT

A system, method, and computer-readable medium are disclosed for performing a feature globalization operation comprising: defining a plurality of features for incorporating within a page of a website; selecting certain features from the plurality of features for presentation via the website when the website is accessed from a particular region; and, automatically presenting the certain features via the website when the website is access from the particular region.

### BACKGROUND OF THE INVENTION

### Field of the Invention

The present invention relates to information handling systems. More specifically, embodiments of the invention relate to configuring constraints when performing a globalization of features when executing a software application.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to use information handling systems to access a website via a web browser executing on the information handling system. It is known that the website may be executed on a web server which is remote to the information handling system executing the web browser.

### SUMMARY OF THE INVENTION

A system, method, and computer-readable medium are disclosed for performing a feature globalization operation comprising: defining a plurality of features for incorporating within a page of a website; selecting certain features from the plurality of features for presentation via the website when the website is accessed from a particular region; and, automatically presenting the certain features via the website when the website is access from the particular region.

In various embodiments, the feature globalization operation provides an extensible and transparent application for adding constraints to sections of configuration representing features of a website. In various embodiments these constraints may be positive (e.g., for particular countries or regions: us, uk) or negative (e.g. except for region: EMEA). In certain embodiments, the feature globalization operation includes a feature section which contains as many constraints as desired. In certain embodiments, the feature globalization operation filters the configuration at run time against user context to produce a final configuration that is used by the application to present the website which corresponds to a particular country or region.

In various embodiments, the feature globalization operation advantageously provides an application which configures global websites by facilitating selection of an option without requiring a knowledge of why the option may be applicable or inapplicable to a particular region. In various embodiments, the feature globalization operation advantageously provides an application which is extensible because as new constraints are added the application, the underlying application code remains the same. In various embodiments, the feature globalization operation advantageously provides an application which is flexible because multiple configurations can be used for different scenarios. In various embodiments, the feature globalization operation advantageously provides an application which is convenient, since variations in configuration related to globalization features can be stored all in one place.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a simplified block diagram of feature globalization environment.

FIG. 3 shows an example of a feature configuration definition.

FIG. 4 shows an example of a feature configuration definition.

FIG. 5 shows an example screen presentation for controlling a left navigation feature of a page.

FIG. 6 shows an example screen presentations for a time to ship feature a price message for product stack feature for a website

FIG. 7 shows an example screen presentation of a signal sources configuration user interface.

FIG. 8 shows an example screen presentation of a strategies user interface.

FIG. 9 shows an example screen presentation of a result options user interface.

FIGS. 10A and 10B, generally referred to as FIG. 10, show example screen presentations of configuration options of a feature customization portion user interface.

FIG. 11 shows an example screen presentation of a recipe tester user interface.

FIG. 12 shows an example screen presentation of a signal sources tab of a recipe tester user interface.

FIG. 13 shows an example screen presentation of a signals tab of a recipe tester user interface.

FIG. 14 shows example screen presentation of a strategies tab of a recipe tester user interface.

FIG. 15 shows an example screen presentation of a results tab of a recipe tester user interface.

FIGS. 16A and 16B, generally referred to as FIG. 16, show example screen presentations of a graph tab of a recipe tester user interface.

### DETAILED DESCRIPTION

Various aspects of the present disclosure include an appreciation that it is desirable to provide an application which facilitates provision of a website. For the purposes of this disclosure a website may be defined as a collection of related web pages which are identified with a common domain name and is published on at least one web server. A website may be accessible via a public internet protocol (IP) network or a private local network. A web page is a document which is accessible via a browser which displays the web page via a display device of an information handling system. In various embodiments, the web page also includes the file which causes the document to be presented via the browser. In various embodiments, the web page may comprise a static web page which is delivered exactly as stored and a dynamic web page which is generated by a web application that is driven by software that enhances the web page via user input to a web server.

Various aspects of the present disclosure include an appreciation that a website may include a global website. For the purposes of this disclosure a global website may be defined as a website which is accessible from a plurality of countries or regions. Various aspects of the present disclosure include a recognition that global websites should include content that is specific to one or more languages and cultures of a particular country or region. Additionally, it is desirable that global websites include the functionality which accounts for different regulations and business models in various countries and/or regions.

In various embodiments, the feature globalization operation provides an ability to specify different subsets of features for websites that are accessed that are accessed by users from different countries or regions. In various embodiments, the feature globalization operation provides a solution that allows mapping of features to globalization restrictions in a way that is transparent to the application and that also allows extension of the capabilities of the website.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

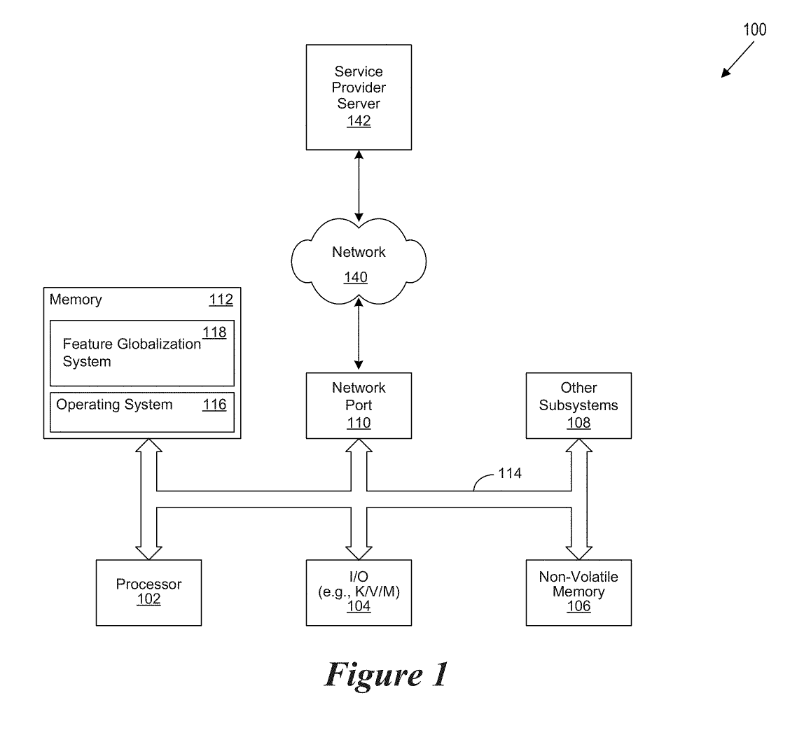

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114.

System memory 112 further comprises operating system (OS) 116 and in various embodiments may also comprise a feature globalization system 118.

The feature globalization system 118 performs a feature globalization operation. The feature globalization operation improves processor efficiency (and thus the efficiency of the information handling system 100) by improving the efficiency of accessing features across a plurality of information handling systems.

As will be appreciated, once the information handling system 100 is configured to perform the feature globalization operation, the information handling system 100 becomes a specialized computing device specifically configured to perform the feature globalization operation and is not a general purpose computing device. Moreover, the implementation of the feature globalization operation on the information handling system 100 improves the functionality of the information handling system and provides a useful and concrete result of customizing features of a web page based upon a region from which the web page is accessed.

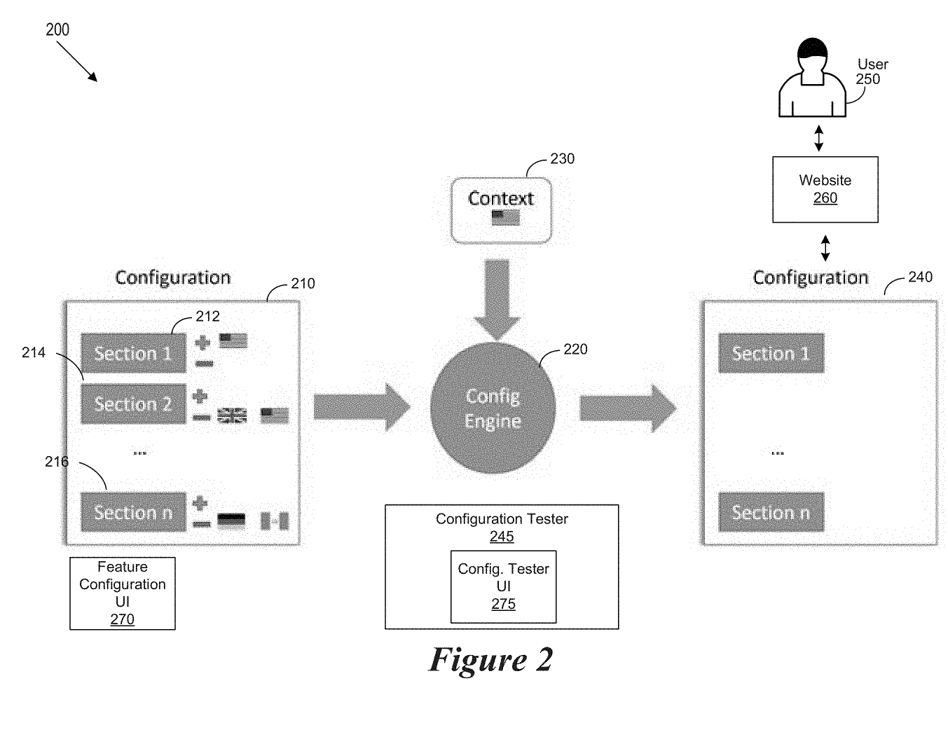

Referring to FIG. 2, a block diagram of a feature globalization environment 200 is shown. More specifically, the feature globalization environment 200 includes a feature configuration portion 210, a configuration engine 220, a context portion 230 and a configured website portion 240. In certain embodiments, the feature globalization environment 200 further includes a configuration tester 245 (also referred to as a recipe tester). In certain embodiments, the feature configuration portion 210 includes one or more feature sections 212, 214, 216. In certain embodiments, each of the feature sections 212, 214, 216 includes respective associated regions. In certain embodiments a user 250 accesses a website 260 which reads the configuration generated by the configuration engine and adjusts itself appropriately.

In certain embodiments, the feature configuration portion 210 includes a feature configuration user interface portion 270 which provides one or more feature configuration screen presentations for enabling a user to perform a feature configuration operation. In certain embodiments, the configuration tester 245 includes a configuration tester user interface portion 275 which provides one or more configuration tester screen presentations for enabling a user to perform a recipe test operation. It will be appreciated that the feature configuration portion 210, the configuration engine 220, the context portion 230, the configured website portion 240 and the configuration tester 245 may execute on a hardware processor of one or more information handling systems such as server type information handling systems.

At runtime, when a user makes a request of a website (i.e., accesses a website from a particular region, the configuration engine 220 accesses an augmented configuration provided by the feature configuration portion 210 and filters the augmented configuration based on the request context. The result is a website configuration provided via the configured website portion 240 that only includes sections (e.g., some or all of section 1-section n) valid in for the current context.

In certain embodiments, the configuration engine 220 provides modules that are identified via the feature configuration portion 210 and the configuration engine 220. The configured website portion 240 loads only the modules present in the configuration. In certain embodiments, for when loading the modules, any options and/or flags associated with missing entries are assumed to be false and are not loaded. When performing such a feature globalization operation, turning modules on and off is transparent to the end user. In certain embodiments, when determining whether to include certain options within the website, the feature globalization operation determines whether to include the certain options based upon the options selected (or not selected) via the feature globalization portion 210; however, there is no need to have any knowledge about the context of the options. Additionally, the context does not have to be modified when making a determination of whether to add, update or modify any constraints selected via the feature configuration portion 210.

In certain embodiments, the configured website portion 240 is presented via a configured pages on a website. In certain embodiments, the feature configuration portion 210 includes a plurality of preconfigured configurations. In certain embodiments, information to facilitate configuration of a preconfigured configuration is stored as an associated configuration. In certain embodiments, the feature configuration portion 210 includes associated configuration recipes relating to for a main website, for a suggestions portion of the website, for a windows 10 application portion of the website, etc.

Because feature configuration environment includes loosely coupled elements, the elements may be developed independently of any globalization needs of an organization. Also, because the constraint system is generic, the feature configuration environment may be extended to be used in conjunction with an experimentation engine as well as the configuration engine.

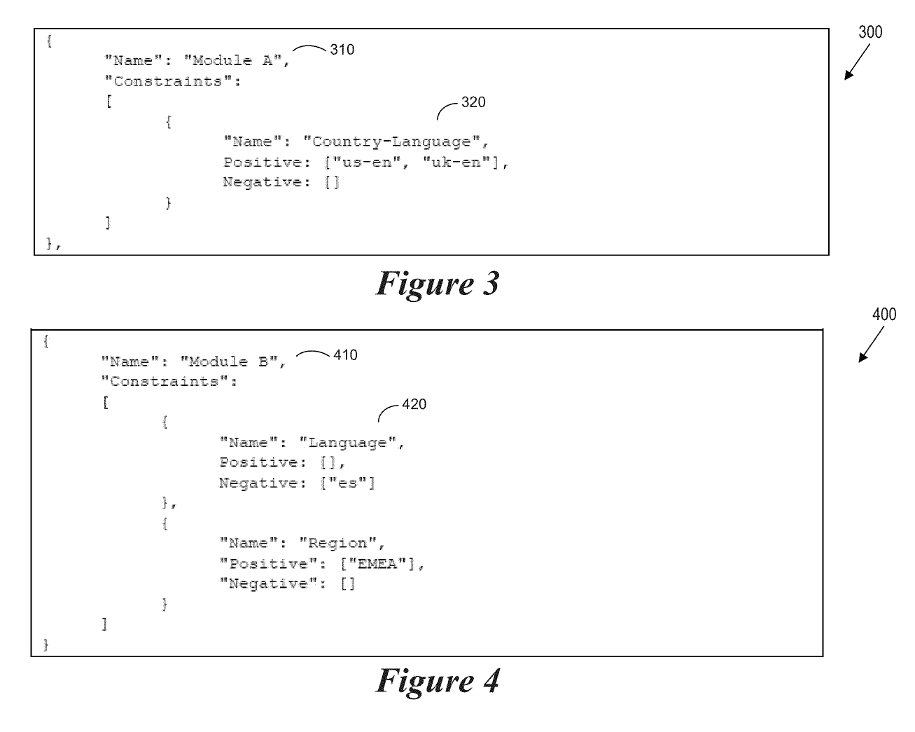

Referring to FIG. 3, an example of a feature configuration definition 300 is shown. More specifically, the feature configuration definition 300 includes a configuration portion 310 and a runtime feature calculation portion 320. The configuration portion 310 identifies the module or option which is being configured. In certain embodiments, the module or option corresponds to a second of a page of a website. For example, the name of the module being configured via the feature configuration definition 300 is set forth as Module A. The runtime feature calculation portion 320 identifies a feature that is associated with the identified module or option. Each section can have zero to many constraints. A constraint has an associated name and can have positive and/or negative values. For example, at runtime the runtime feature calculation portion 320 of the feature definition 300 specifies that module A should be present when the country is the United States and the language is English or when the country is the United Kingdom and the Language is English. It will be appreciated that while the example is set forth using JavaScript Object Notation (JSON), other formats (e.g., extensible markup language (XML)) are also contemplated.

Referring to FIG. 4, an example of a feature configuration definition 400 is shown. More specifically, the feature configuration definition 400 includes a configuration portion 410 and a runtime feature calculation portion 420. The configuration portion 410 identifies the module or option which is being configured. In certain embodiments, the module or option corresponds to a second of a page of a website. For example, the name of the module being configured via the feature configuration definition 400 is set forth as Module B. The runtime feature calculation portion 420 identifies a feature that is associated with the identified module or option. Each section can have zero to many constraints. A constraint has an associated name and can have positive and/or negative values. For example, at runtime the runtime feature calculation portion 420 of the feature definition 400 specifies that module B should be available for all pages presented within the Europe, Middle East and Africa (EMEA) region except when the language is Spanish. It will be appreciated that while the example is set forth using JavaScript Object Notation (JSON), other formats (e.g., extensible markup language (XML)) are also contemplated.

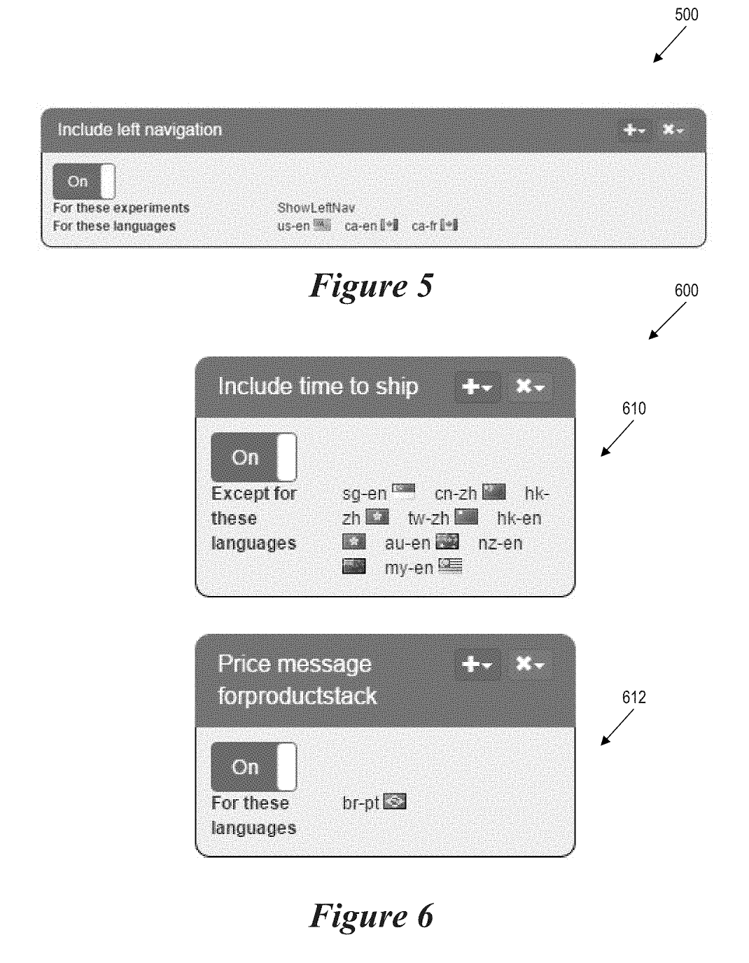

Referring to FIG. 5, an example screen presentation 500 for controlling a left navigation feature of a page is shown. More specifically, the screen presentation 500 includes a control feature (e.g., a button) which may be actuated to identify when to implement a certain feature for certain regions. Whether the feature is selected or not, the configuration engine 220 automatically generates a feature configuration definition corresponding to the control feature. The screen presentation 500 also includes a language portion via which languages for which the certain feature are to be implemented may be selected. This feature configuration definition is then used to build a specification to which the website may configure itself.

Referring to FIG. 6, example screen presentations 600 for a time to ship feature and a price message for product stack feature for a website are shown. More specifically, the screen presentation 600 includes a time to ship screen presentation 610 and a price message screen presentation 612. The time to ship screen presentation 610 includes a control feature (e.g., a button) which may be actuated to identify when to include a time to ship feature for certain regions. Whether the feature is selected or not, the configuration engine 220 automatically generates a feature configuration definition corresponding to the control feature. The screen presentation 610 also includes a language portion via which languages for which the certain feature are to be implemented may be selected. This feature configuration definition is then used to build a specification to which the website may configure itself. With the time to ship screen presentation 610 a time to ship will be included except for the following country-languages: Singapore English, Chinese Chinese, Hong Kong Chinese, Australian English, New Zealand English and Myanmar English. The price message for product stack feature screen presentation 612 includes a control feature (e.g., a button) which may be actuated to identify when to include prices message for a product stack for certain regions. Whether the feature is selected or not, the configuration engine 220 automatically generates a feature configuration definition corresponding to the control feature. The screen presentation 612 also includes a language portion via which languages for which the certain feature are to be implemented may be selected. With the price message for product stack feature screen presentation 612, a price message for product stack will be included only for Brazilian Portuguese.

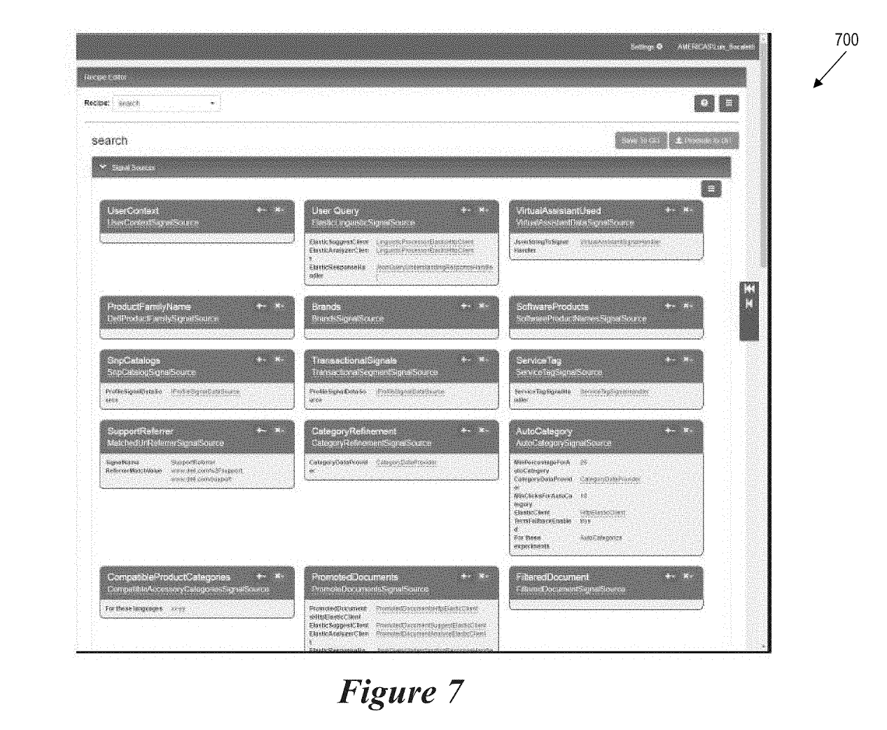

Referring to FIG. 7, an example screen presentation 700 of a signal sources configuration portion of a configuration editor user interface is shown. The signal sources portion of the configuration editor user interface includes a plurality of feature customization portions for controlling respective features of a website. For example, the configuration editor user interface includes one or more of a user context feature portion, a user query feature portion, a virtual assistant used feature portion, a product family name feature portion, a brands feature portion, a software products feature portion, a software and peripherals (snp) catalogs feature portion, a transactional signals feature portion, a service tag feature portion, a support referrer feature portion, a category refinement feature portion, an auto category feature portion, a compatible product categories feature portion, a promoted documents feature portion and a filtered document feature portion. In certain embodiments, some or all of the feature portions include a link to a signal source corresponding to the feature of the feature portion. In certain embodiments, some or all of the feature portions include a plurality of links to one or more data sources corresponding to the feature of the feature portion.

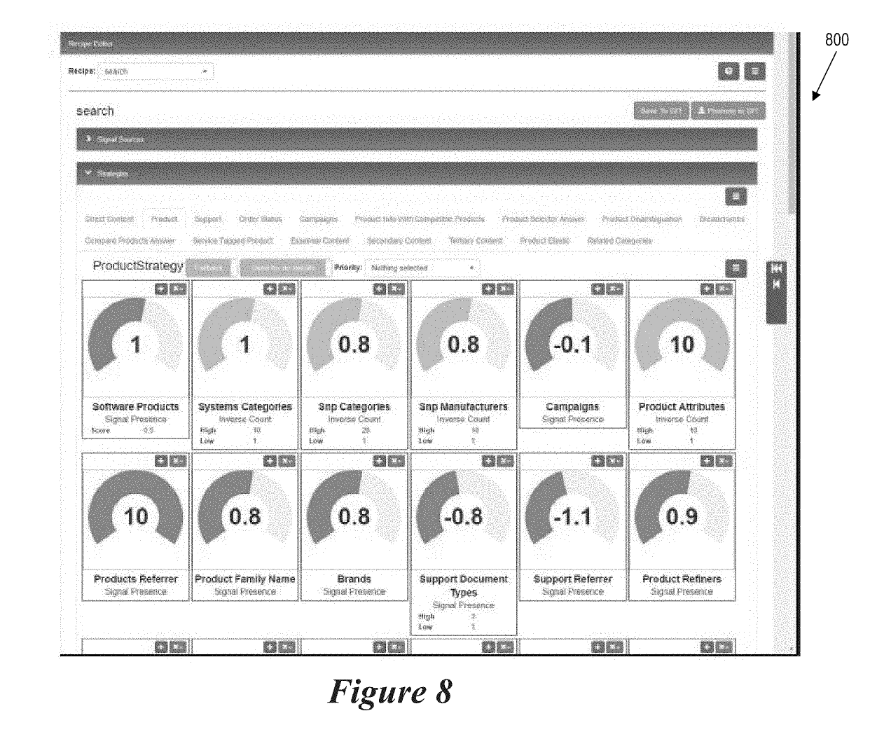

Referring to FIG. 8, an example screen presentation 800 of a strategies user interface is shown. The strategies user interface provides a plurality of components which are used when generating a page or website based upon a search by a user. These strategies may be adjusted during the feature customization operation to take into account various aspects of a page or website when generating a page based upon a search.

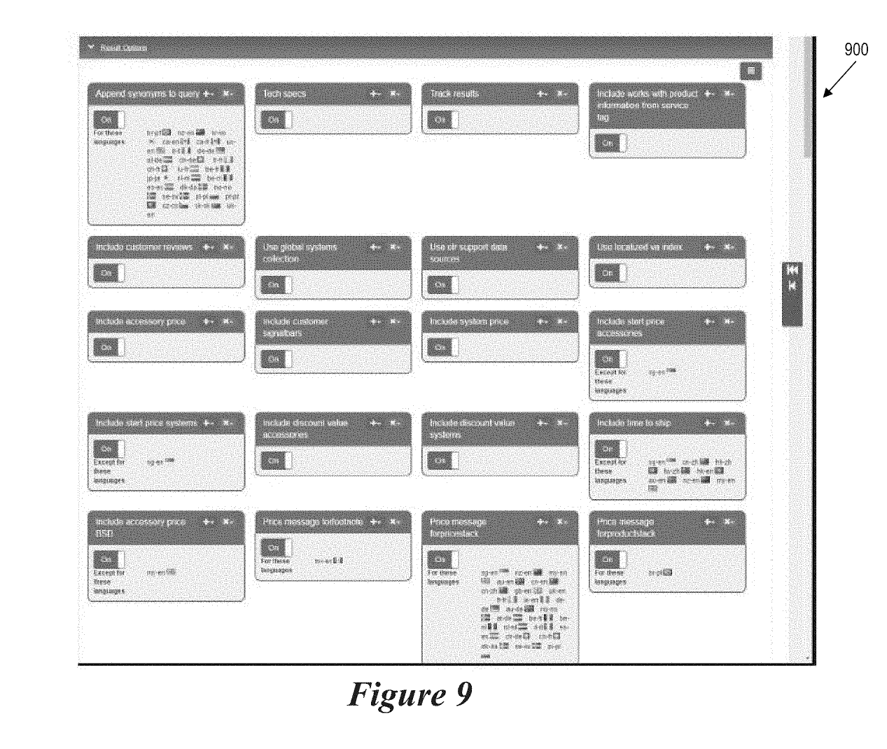

Referring to FIG. 9, an example screen presentation 900 of a result options user interface is shown. The result options user interface provides a plurality of feature selection portions that may be used when generating a page based upon a search by a user.

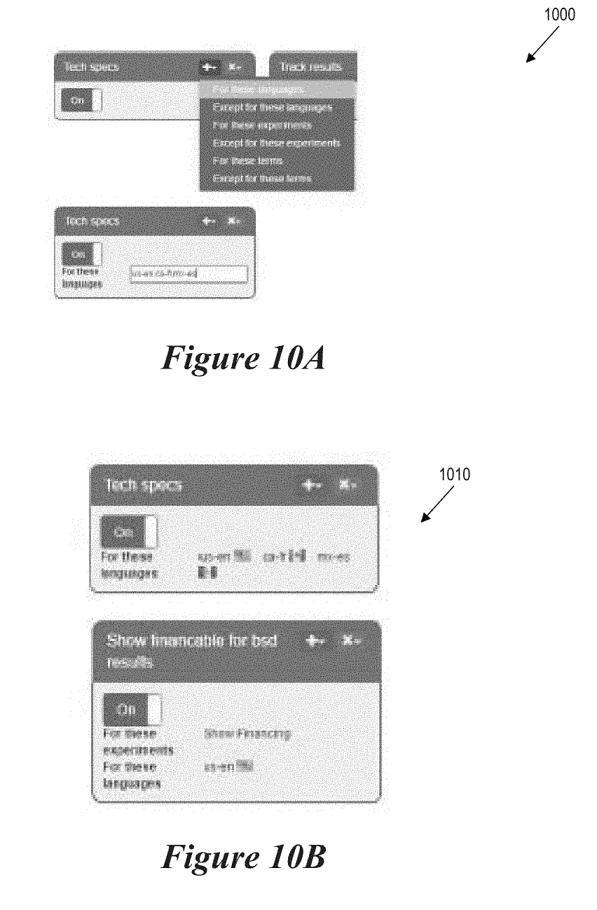

Referring to FIGS. 10A and 10B, example screen presentations 1000 of configuration options of a feature customization portion user interface are shown. More specifically, a feature customization portion user interface may use a drop down menu to select options to be configured via the feature portion. The feature customization portion user interface may also include a data entry portion via which options (e.g., language regions) may be identified via the feature portion. After the options are identified, the feature customization portion user interface may include a region identification portion via which the identified options are presented within the feature portion user interface (see e.g., feature portion user interface 1010 of FIG. 10B). In certain embodiments, the identified options may include an associated graphical icon (e.g., a flag icon) which provides another way of identifying an identified option (e.g., a language region).

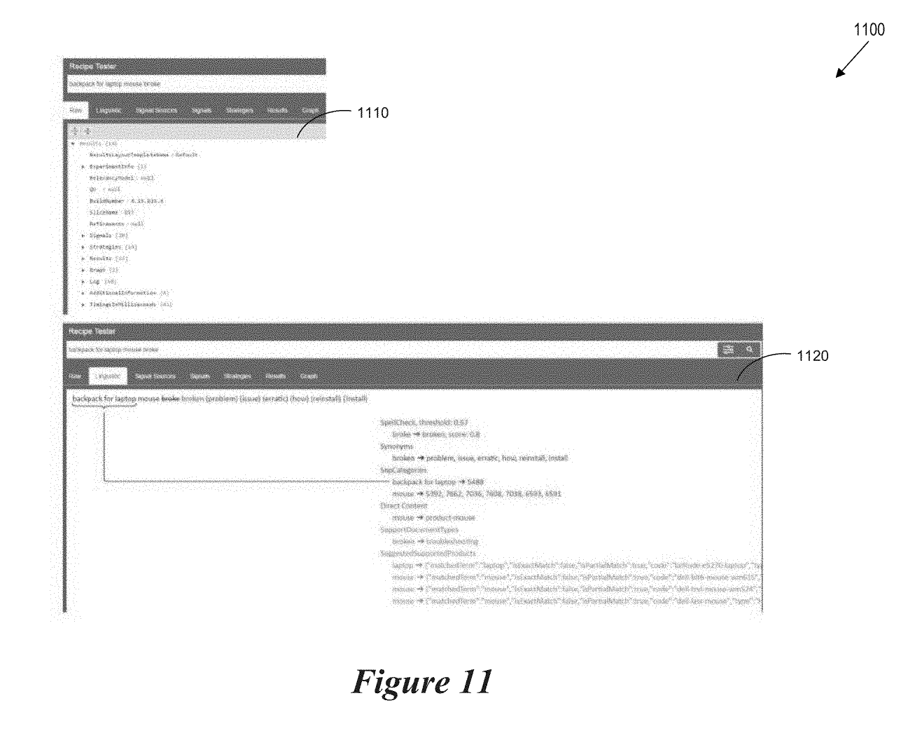

Referring to FIG. 11, an example screen presentation 1100 of a configuration tester user interface is shown. More specifically, the screen presentation 1100 includes a raw data portion 1110 showing a recipe test of a test phrase as well as a linguistic portion 1120 of a recipe test of a test phrase.

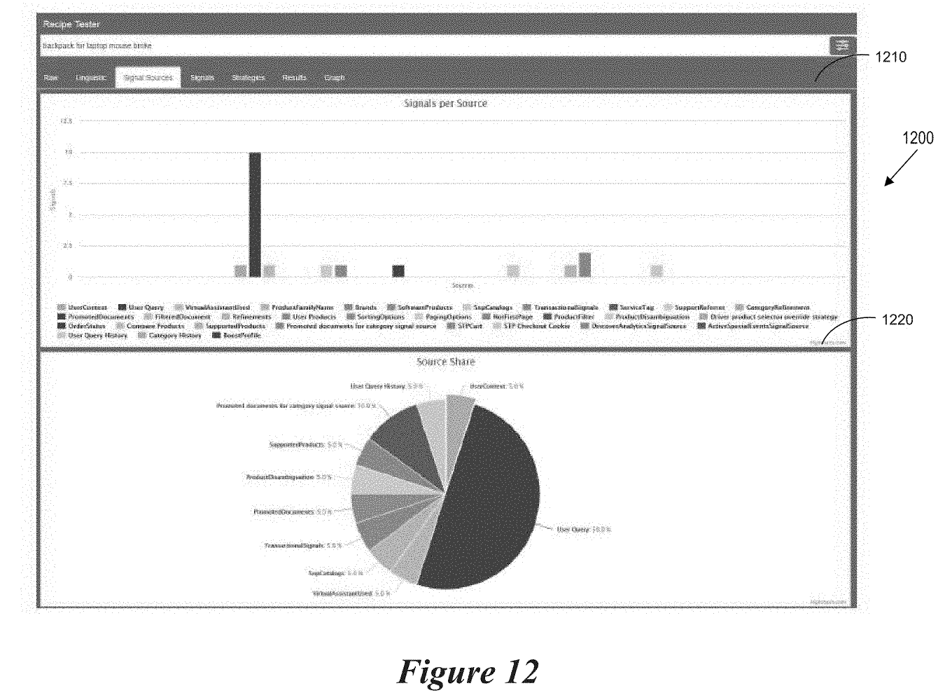

Referring to FIG. 12, an example screen presentation 1200 of a signal sources tab of a recipe tester user interface is shown. More specifically, the screen presentation 1200 includes a signal per source portion 1210 as well as a source share portion 1220.

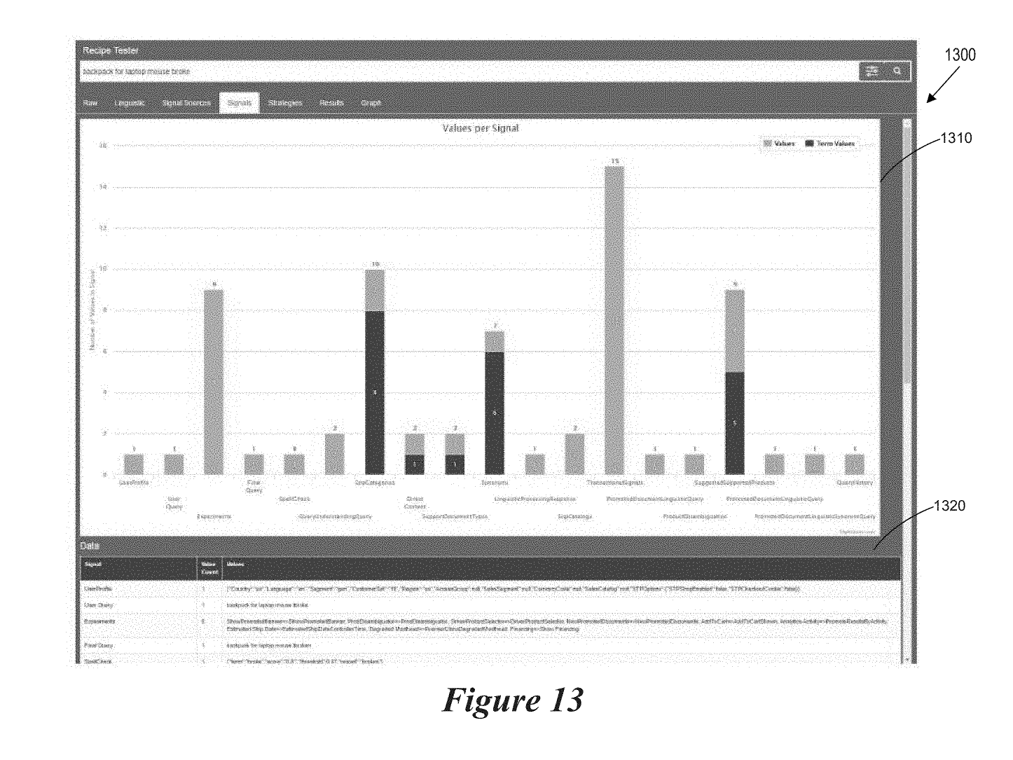

Referring to FIG. 13, an example screen presentation 1300 of a signals tab of a recipe tester user interface is shown. More specifically, the screen presentation 1300 includes a values per signal portion 1310 as well as a signal data portion 1320.

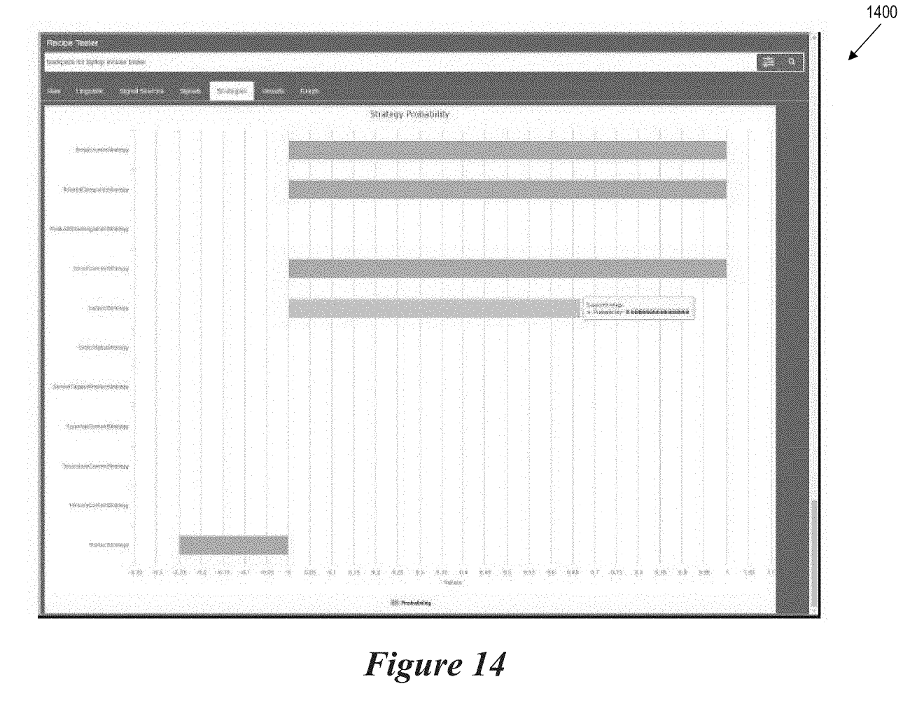

Referring to FIG. 14, an example screen presentation 1400 of a strategies tab of a recipe tester user interface is shown. More specifically, the screen presentation 1400 includes a strategy probability portion.

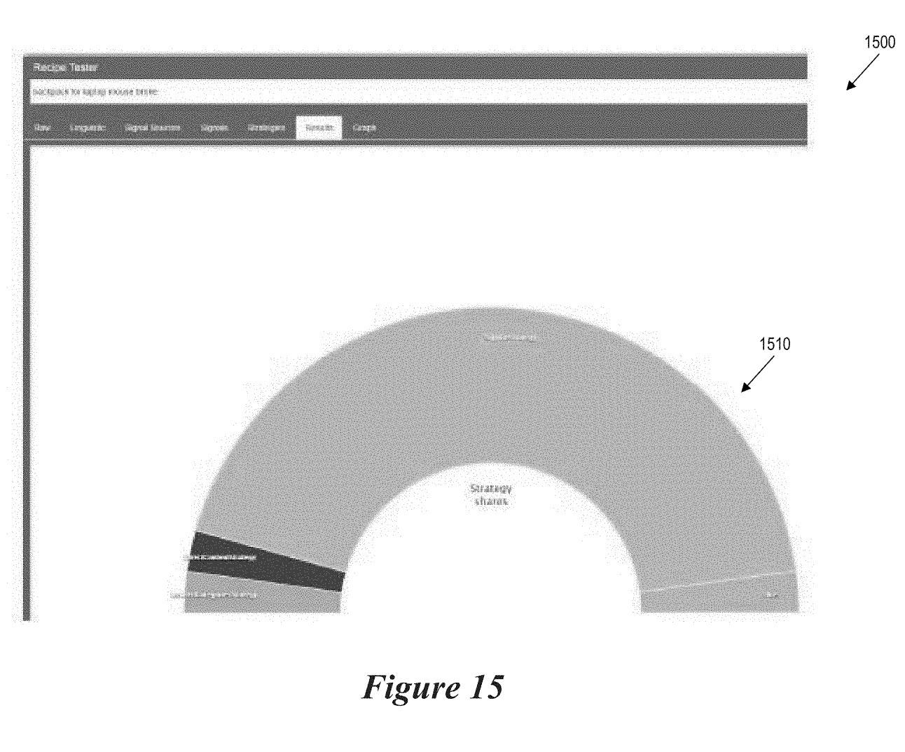

Referring to FIG. 15, an example screen presentation 1500 of a results tab of a recipe tester user interface is shown. More specifically, the screen presentation 1500 includes a strategy results portion 1510.

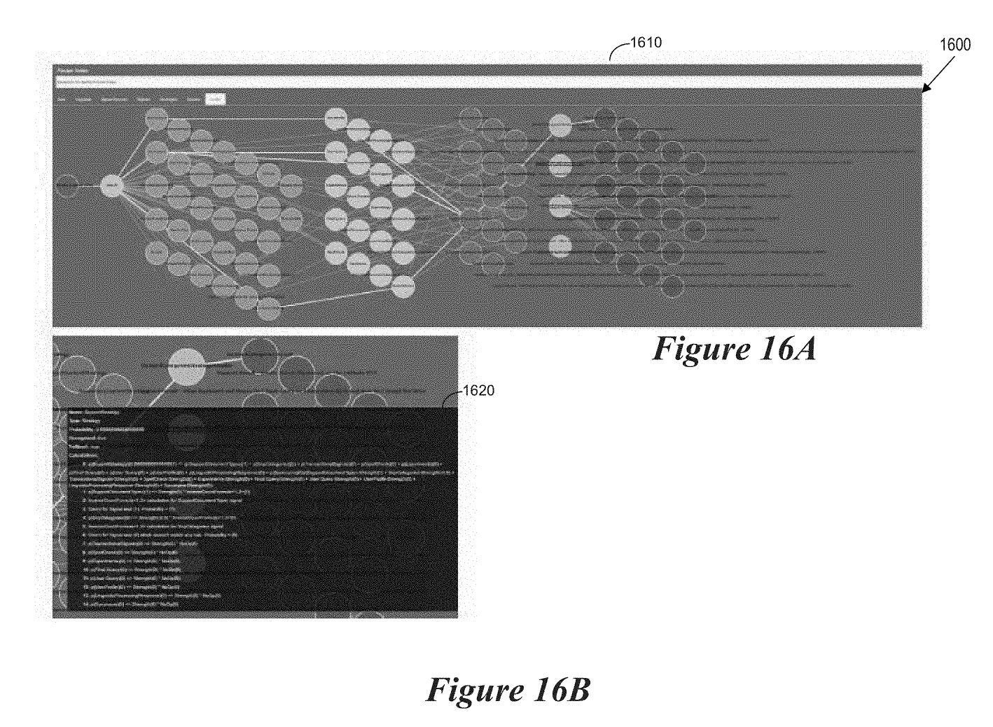

Referring to FIGS. 16A and 16B, example screen presentations 1600 of a graph tab of a recipe tester user interface is shown. More specifically, the screen presentation 1600 includes a graph portion 1610. Selecting a particular icon within the graph portion 1610 then causes presentation of a results detail user interface 1620 (see e.g., FIG. 16B).

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a feature globalization operation, comprising:
defining a plurality of features for incorporating within a page of a website;
selecting certain features from the plurality of features for presentation via the website when the website is accessed from a particular region;
automatically presenting the certain features via the website when the website is access from the particular region.

2. The method of claim 1, wherein:
a feature of the certain features adds a constraint to a section of configuration representing features of a website.

3. The method of claim 2, wherein:
the constraint comprises at least one of a positive constraint and a negative constraint.

4. The method of claim 1, wherein:
the automatically presenting comprises filtering the certain features at run time against user context to produce a final configuration, the final configuration being used to present a configured website corresponding to a particular region.

5. The method of claim 1, further comprising:
storing a plurality of the certain features within a configuration recipe; and,
applying the configuration recipe at runtime when performing the automatically presenting.

6. The method of claim 5, further comprising:
performing a recipe test operation on the configuration recipe, the recipe test operation determining whether the configuration recipe functions properly for a plurality of regions.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
defining a plurality of features for incorporating within a page of a website;
selecting certain features from the plurality of features for presentation via the website when the website is accessed from a particular region;
automatically presenting the certain features via the website when the website is access from the particular region.

8. The system of claim 7, wherein:
a feature of the certain features adds a constraint to a section of configuration representing features of a website.

9. The system of claim 8, wherein:
the constraint comprises at least one of a positive constraint and a negative constraint.

10. The system of claim 7, wherein:
the automatically presenting comprises filtering the certain features at run time against user context to produce a final configuration, the final configuration being used to present a configured website corresponding to a particular region.

11. The system of claim 7, wherein the instructions are further configured for:
storing a plurality of the certain features within a configuration recipe; and,
applying the configuration recipe at runtime when performing the automatically presenting.

12. The system of claim 11, wherein the instructions are further configured for:
performing a recipe test operation on the configuration recipe, the recipe test operation determining whether the configuration recipe functions properly for a plurality of regions.

13. A non-transitory, computer-readable storage medium embodying computer program code, the computer program code comprising computer executable instructions configured for:
defining a plurality of features for incorporating within a page of a website;
selecting certain features from the plurality of features for presentation via the website when the website is accessed from a particular region;
automatically presenting the certain features via the website when the website is access from the particular region.

14. The non-transitory, computer-readable storage medium of claim 13, wherein:
a feature of the certain features adds a constraint to a section of configuration representing features of a website.

15. The non-transitory, computer-readable storage medium of claim 14, wherein:
the constraint comprises at least one of a positive constraint and a negative constraint.

16. The non-transitory, computer-readable storage medium of claim 13, wherein:
the automatically presenting comprises filtering the certain features at run time against user context to produce a final configuration, the final configuration being used to present a configured website corresponding to a particular region.

17. The non-transitory, computer-readable storage medium of claim 13, wherein the computer executable instructions are further configured for:
storing a plurality of the certain features within a configuration recipe; and,
applying the configuration recipe at runtime when performing the automatically presenting.

18. The non-transitory, computer-readable storage medium of claim 17, wherein the computer executable instructions are further configured for:
performing a recipe test operation on the configuration recipe, the recipe test operation determining whether the configuration recipe functions properly for a plurality of regions.
